(19) United States
(12) Patent Application Publication
(10) Pub. No.: US 2010/0250355 A1
(43) Pub. Date: Sep. 30, 2010

(54) Redemption of Reward Points as Cash and Deposit of Cash to Checking, Savings or Other Accounts

(75) Inventors: Mark McInnes, West Chester, PA (US); Rex Oberg, Chadds Ford, PA (US); Michael T. deLaveaga, Newark, DE (US); Daniel C. Maddox, Coatesville, PA (US); Olaf G. Schweidler, West Chester, PA (US)

Correspondence Address: BANNER & WITCOFF, LTD;ATTORNEYS FOR CLIENT NUMBER 007131, 10 SOUTH WACKER DR., SUITE 3000, CHICAGO, IL, 60606, US

(73) Assignee: Bank of America Corporation, Charlotte, NC (US)

(21) Appl. No.: 12/414,650

(22) Filed: Mar. 30, 2009

(51) Int. Cl. G06Q 30/00; G06Q 20/00

(52) U.S. Cl. 705/14.18; 705/14.17; 705/34; 705/40

(57) ABSTRACT

Systems and methods of redeeming reward points for cash and depositing the cash to a checking or savings account of a user is presented. In some arrangements, the user will input account information relating to one or more checking or savings accounts. The information may be stored by the system. The user may select to redeem some or all of the reward points in his or her reward account balance as cash. Upon selection of this option, the user may select one or more of the saved accounts to which the funds will be deposited. In some arrangements, the redemption may occur automatically upon occurrence of a triggering event or meeting a predetermined threshold.

### BACKGROUND

Credit card companies, financial institutions, and the like are often competing for customers in today's consumer world. Offering reward programs associated with use of credit card or financial institution products is one way to lure customers to use those products. Some existing reward redemption programs only offer redemption of rewards as credit to the credit card account or in the form of a check paid to the user. These redemption options may be limiting and/or inconvenient to the user. For example, if a check is issued, the check may be stolen before the customer can even make a deposit or the customer may lose or forget to deposit the check altogether.

In addition, credit card reward programs often have one system and method of redemption for all reward accounts. While this simplifies management of the reward accounts because all are managed in the same way and with the same functionality, criteria, etc., this may again be limiting and/or inconvenient to the user. A system and method of providing management of individual reward accounts or groups of accounts, as well as a system and method of directly depositing cash rewards to a user checking or savings account is desired.

### SUMMARY

The following presents a simplified summary in order to provide a basic understanding of some aspects of the invention. The summary is not an extensive overview of the invention. It is neither intended to identify key or critical elements of the invention nor to delineate the scope of the invention. The following summary merely presents some concepts of the invention in a simplified form as a prelude to the description below.

Aspects of this disclosure relate to a system for redemption of rewards from a credit card reward program, comprising a user interface module for receiving account information identifying a checking or savings account into which rewards converted into cash are deposited. The system further includes a back end resolution module for determining if a predetermined condition is met, and a finalization module for depositing cash into the checking or savings account when the predetermined condition is met.

Aspects of the disclosure further relate to a method of redeeming rewards from a credit card rewards program, comprising receiving, at a central server, information relating to a checking or savings account of a user. The method further includes determining, at the central server, that a predetermined condition has been met and responsive to determining that the predetermined condition has been met, redeeming points in a reward balance for cash. The method further includes depositing the cash into the checking or savings account. The method may be conducted in an on-demand fashion or may occur automatically upon meeting the predetermined condition.

### BRIEF DESCRIPTION OF THE DRAWINGS

The present disclosure is illustrated by way of example and not limited in the accompanying figures in which like reference numerals indicate similar elements.

FIG. 1 illustrates an example of a suitable operating environment in which various aspects of the disclosure may be used.

FIG. 2 illustrates a simplified diagram of a universal savings director in which reward points or credits may be redeemed as cash and deposited into a user's checking or savings account as described herein in accordance with an aspect of the invention.

FIG. 3 is an example method of redeeming reward points for cash and depositing the cash reward into a user checking or savings account in accordance with aspects of the invention.

FIG. 4 illustrates an example user interface for adding a checking or savings account to which cash rewards may be deposited to the universal savings director system in accordance with various aspects of the invention.

FIG. 5 is an example user interface for inputting account information for a user checking account to which cash rewards may be deposited in accordance with one or more aspects of the invention.

FIG. 6 illustrates one example user interface for confirming user account information according to aspects described herein.

FIG. 7 illustrates one example user interface for selecting one or more accounts to which a cash reward will be deposited according to aspects described herein.

FIG. 8 illustrates one example user interface for receiving a desired amount of cash or reward points to redeem and deposit as cash into the account(s) selected in FIG. 7, according to aspects described herein.

FIG. 9 is an example user interface for confirming the desired redemption amount input in FIG. 8, according to aspects described herein.

FIG. 10 is an example user interface showing a transaction confirmation to indicate that the desired redemption and deposit have been made, according to aspects described herein.

FIG. 11 is an example user interface illustrating an alternate method of receiving the desired amount for redemption and automatically redeeming that amount and crediting a desired account according to aspects described herein.

FIG. 12 is an example method of automatically redeeming a predetermined amount of points for cash and automatically depositing the cash in one or more selected user checking and/or savings accounts according to aspects described herein.

FIG. 13 is an example method of conducting the transactions of FIGS. 3-12 via a call center operator according to aspects described herein.

FIG. 14 illustrates one example method of paying bills directly from the redeemed cash amount according to aspects described herein.

The reader is advised that the attached drawings are not necessarily drawn to scale.

### DETAILED DESCRIPTION

Aspects of the present disclosure relate to reward programs, such as credit card reward programs and the like. For instance, as purchases are made using a credit card, a user can receive rewards such as cash back, airline miles, redeemable points, and the like. In order to manage these reward benefits, a universal saving director system, such as described herein, may be used. The universal saving director includes functionality directed to redeeming reward points or credits for cash and automatically transferring the redeemed cash reward to a user's account at a financial institution, such as a checking or savings account, brokerage, mortgage, retirement account, and the like. In addition, the universal saving director may include a user interface through which a user may save accounts and, in some instances, permit a user to assign a nickname to an account. Further, the universal saving director may provide an automated sweep system in which user rewards are automatically transferred to a predetermined account on a periodic or aperiodic basis.

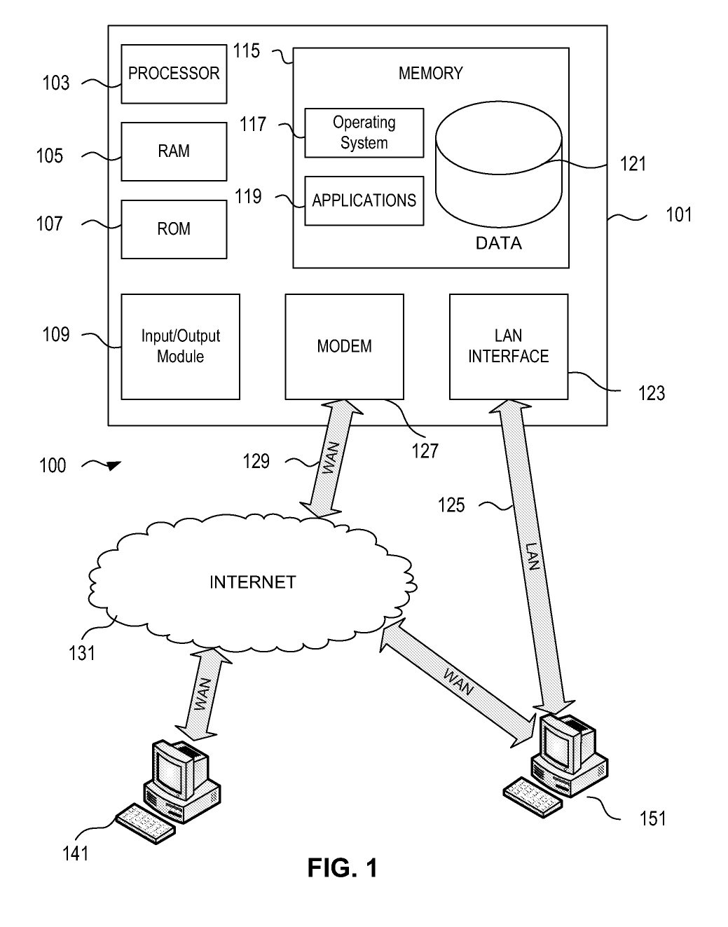

FIG. 1 illustrates a block diagram of a generic computing device 101 (e.g., a computer server) in computing environment 100 that may be used according to an illustrative embodiment of the disclosure. The computer server 101 may have a processor 103 for controlling overall operation of the server and its associated components, including RAM 105, ROM 107, input/output module 109, and memory 115.

I/O 109 may include a microphone, mouse, keypad, touch screen, scanner, optical reader, and/or stylus (or other input device(s)) through which a user of server 101 may provide input, and may also include one or more of a speaker for providing audio output and a video display device for providing textual, audiovisual and/or graphical output. Software may be stored within memory 115 and/or other storage to provide instructions to processor 103 for enabling server 101 to perform various functions. For example, memory 115 may store software used by the server 101, such as an operating system 117, application programs 119, and an associated database 121. Alternatively, some or all of server 101 computer executable instructions may be embodied in hardware or firmware (not shown).

The server 101 may operate in a networked environment supporting connections to one or more remote computers, such as terminals 141 and 151. The terminals 141 and 151 may be personal computers or servers that include many or all of the elements described above relative to the server 101. The network connections depicted in FIG. 1 include a local area network (LAN) 125 and a wide area network (WAN) 129, but may also include other networks. When used in a LAN networking environment, the computer 101 is connected to the LAN 125 through a network interface or adapter 123. When used in a WAN networking environment, the server 101 may include a modem 127 or other network interface for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP and the like is presumed.

Additionally, an application program 119 used by the server 101 according to an illustrative embodiment of the disclosure may include computer executable instructions for invoking functionality related to reward programs, redemption of reward credits, and the like, as further described herein.

Computing device 101 and/or terminals 141 or 151 may also be mobile terminals (e.g., mobile phones, PDAs, notebooks, etc.) including various other components, such as a battery, speaker, and antennas (not shown).

The disclosure is operational with numerous other general purpose or special purpose computing system environments or configurations. Examples of well known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The disclosure may be described in the general context of computer-executable instructions, such as program modules, being executed by a computer. Generally, program modules include routines, programs, objects, components, data structures, etc. that perform particular tasks or implement particular abstract data types. Aspects of the disclosure may also be practiced in distributed computing environments where tasks are performed by remote processing devices that are linked through a communications network. In a distributed computing environment, program modules may be located in both local and remote computer storage media including memory storage devices.

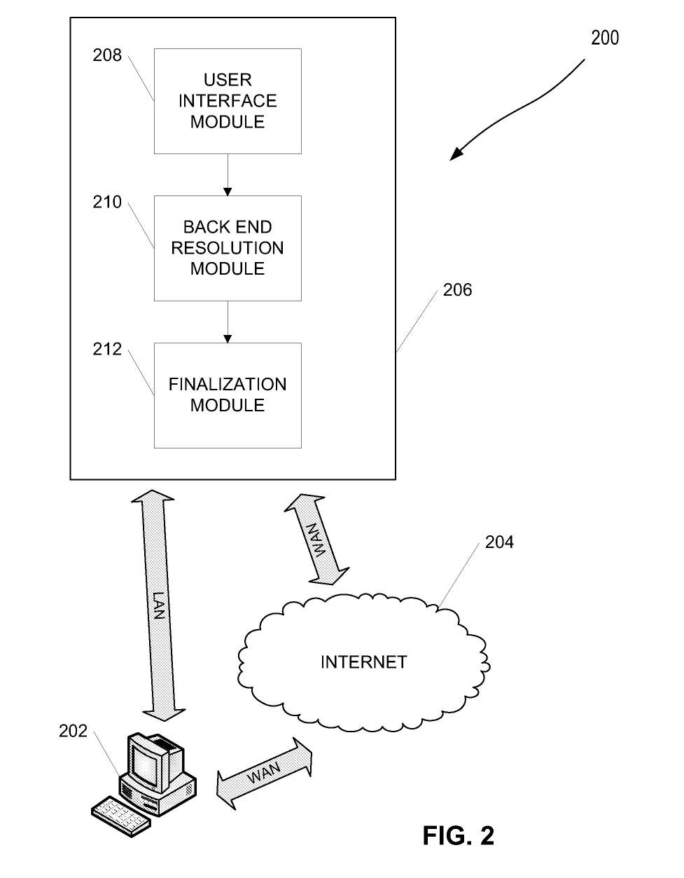

FIG. 2 illustrates one example universal savings director system 200 as described herein.

A user may access, set-up, etc. the desired rewards benefit at a general computing device 202. The general computing device 202 is connected, via a network, such as Internet 204, to a central server 206 associated with a financial institution. The central server 206 contains hardware and software configured to perform functions associated with the universal saving director 200. For instance, the central server 206 includes hardware and software configured to set-up a reward account for a user. Further, the server 206 may be configured to permit a user to modify an account, etc.

The central server 206 may include a user interface module 208, such as a web module, configured to interface with a user via a network, such as the Internet. The user interface module 208 may be configured to receive account information, redemption selections, and the like from a user. For instance, a user may select a type of reward, such as cash back, points, etc. at the user interface module 208. Further, the user may configure various reward selections, such as selecting an on demand redemption of a reward, selecting an automatic redemption at a predetermined time or date, and the like. Further still, the user interface module 208 is configured to receive account information from the user in order to direct cash back rewards to a user specified account, such as a checking or savings account. In some arrangements, the user checking and/or savings account may be pre-existing accounts of the user. The user interface module 208 may also be configured to authenticate a user attempting to access the system. For instance, the user interface module 208 may verify a username and password of a user prior to allowing the user access to the universal saving director system 200.

In addition, the central server 206 may include a back end resolution module 210. This module 210 may be configured to determine when various predetermined conditions are met in order to provide a desired reward outcome. For instance, the back end resolution module 210 may be configured to determine that the predetermined date or time selected by a user for automatic reward redemption has occurred. The central server 206 may also include a finalization module 212 configured to deposit or credit a designated user account with the redeemed reward amount. The designated user account may be a pre-existing checking or savings account. The account may be associated with the financial institution sponsoring the rewards program or may be another financial institution. The finalization module 212 may also transmit a confirmation of the redemption and associated deposit to the user.

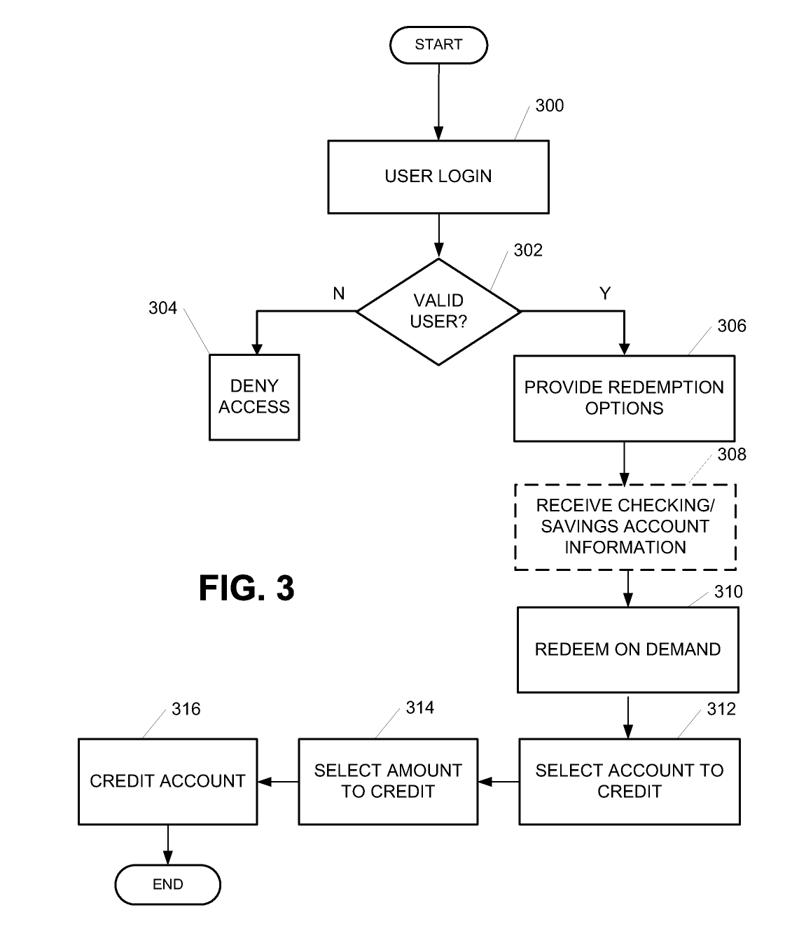

FIG. 3 illustrates one example method of redeeming reward points for cash and depositing the cash directly into a checking or savings account associated with the user. In step 300, user login information is received. The user login information may be received at a central server as described above. In step 302, the user is authenticated to the system. If the login information is invalid, access to the universal savings director system will be denied in step 304. If the login information is valid, the user will be presented with redemption options in step 306. These redemption options may include various methods or forms of redemption, for instance, redemption for airline miles, credit card account credit, cash deposit to checking or savings account, and the like. In optional step 308, checking and/or savings account information associated with one or more accounts of the user may be input into the system in order to credit those accounts with rewards. If user accounts have already been saved in the system, or once the user account information has been input, a redemption option, such as redeem on demand in step 310 may be selected. Upon selection of the redeem on demand option 310, a user may be prompted to select an account, in step 312 to which a cash credit based on reward points or credits redeemed will be deposited. In step 314 the amount to be credited will be selected. The amount credited may be based on the number of reward points or credits available. In some arrangements, the program sponsor may determine the ratio of points redeemed to cash credited. For instance, a program may exchange 10 reward points for one dollar. A user may then redeem all or a portion of the points earned for cash. In step 316, the selected account will be credited with the selected amount. In some arrangements, a confirmation of the account deposit or credit may be transmitted to the user.

In some arrangements, a program sponsor may use various types of reward redemption as incentives for a user to redeem points or credits as cash in a certain account. For instance, a financial institution that is a program sponsor may want to provide an incentive for users to deposit cash rewards to accounts held at the financial institution. Accordingly, the program sponsor may provide a redemption rate of, for example, 1 dollar for every 25 points redeemed if the cash redemption is credited to an account held at another financial institution but may provide 1 dollar for every 20 points redeemed if the cash redemption is credited to an account held at the financial institution.

In still other arrangements, the rate at which the points can be redeemed for cash or the ratio of cash credited to points may be set up in tiers. For instance, for the first 1000 points redeemed, the redemption may be at a rate of 1 dollar for every 50 points. For points 1001 to 5000 redeemed, the rate may be 1 dollar for every 25 points. Continuing this example, for points 5001 to 10000 redeemed, the rate may be 1 dollar for every 10 points. These tiers are merely example tiers and any desired tiers may be established by the program sponsor.

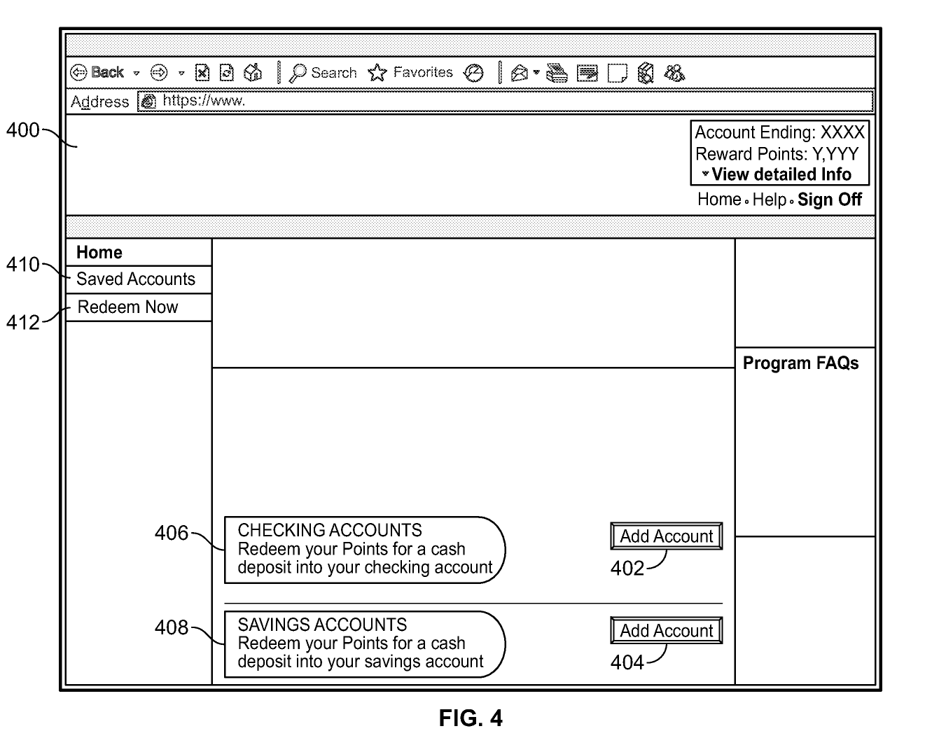

FIG. 4 is one example screen shot associated with a universal savings director described herein. As discussed above, a user may redeem awards points, credits, etc. for cash and may have the cash deposited directly to the user's checking or savings account. FIG. 4 illustrates one screen 400 in which a user may begin set up use of the system. For instance, a user may select the add account option 402 for a checking account to proceed with inputting information, such as an account number, bank routing number, and the like, relating to a checking account to which the user will deposit reward credits. Alternatively, the user may select the add account option 404 for a savings account to proceed with inputting information regarding a savings account to which the user will deposit reward credits. The user may also select either the checking accounts option 406 or the savings accounts option 408 to obtain more information about the process of adding an account, the program itself, etc. As should be understood, other types of accounts, such as an account for a child associated with the user, may be utilized in accordance herein.

FIG. 4 also includes an option to proceed to accounts already saved by selecting the saved accounts option 410 or to proceed with redemption of rewards credit via the redeem now option 412. These selections will be discussed more fully below.

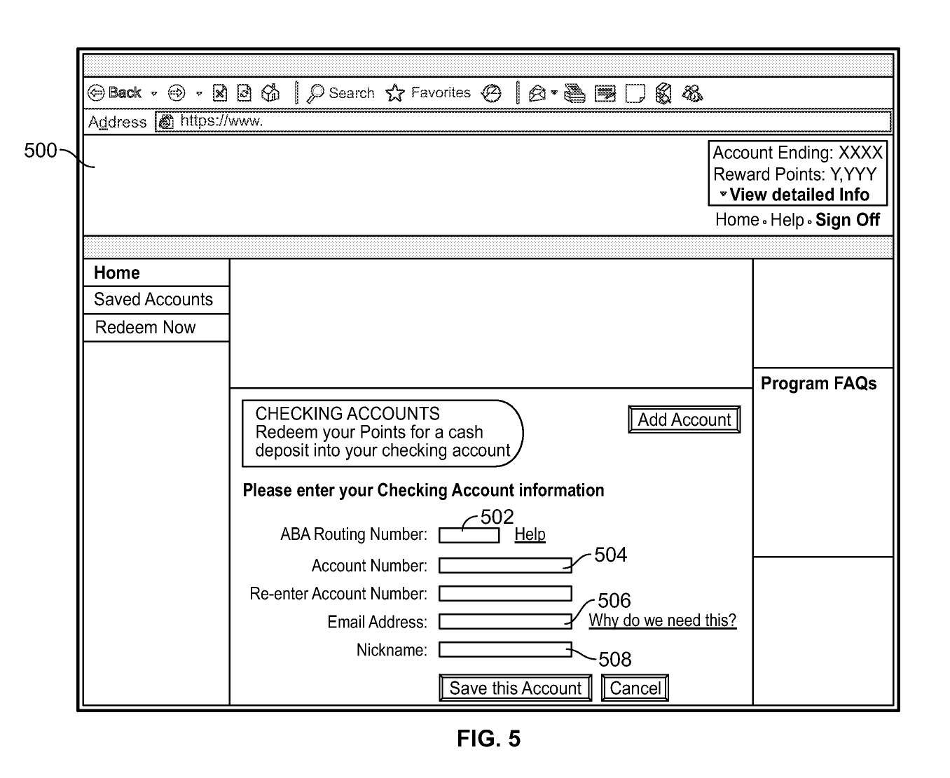

Upon selection of an add account option in FIG. 4, a user may be prompted with an account information input screen, such as screen 500 in FIG. 5. The user may then input information related to the account to which the reward will be deposited. For instance, the user may input the bank routing number in field 502 and account number in field 504 for the desired account. Additionally or alternatively, the user may input an email address in field 506 as a means of confirmation of the user and/or to contact the user.

In some arrangements, the user may be prompted to input a nickname for the account, such as in field 508. The nickname may be any name desired by the user such as “Mark's account,” “Jane's savings account,” and the like, that will simplify identification of the account by the user. For instance, a user may have more than one account saved in the universal savings director system and may select the account to which the funds will be deposited. The nickname may provide a simplified means of identifying and differentiating between multiple accounts.

In still other arrangements, a user who already has accounts established with the financial institution may be prompted to redeem points as cash and deposit in one or more of those accounts. For instance, upon login a user may be prompted with a rewards balance eligible to be redeemed and may be prompted to convert the eligible balance to cash and deposit in an account established with the financial institution. This arrangement may or may not require the user to input the account information. For instance, the financial institution may link the reward account to accounts of the user automatically.

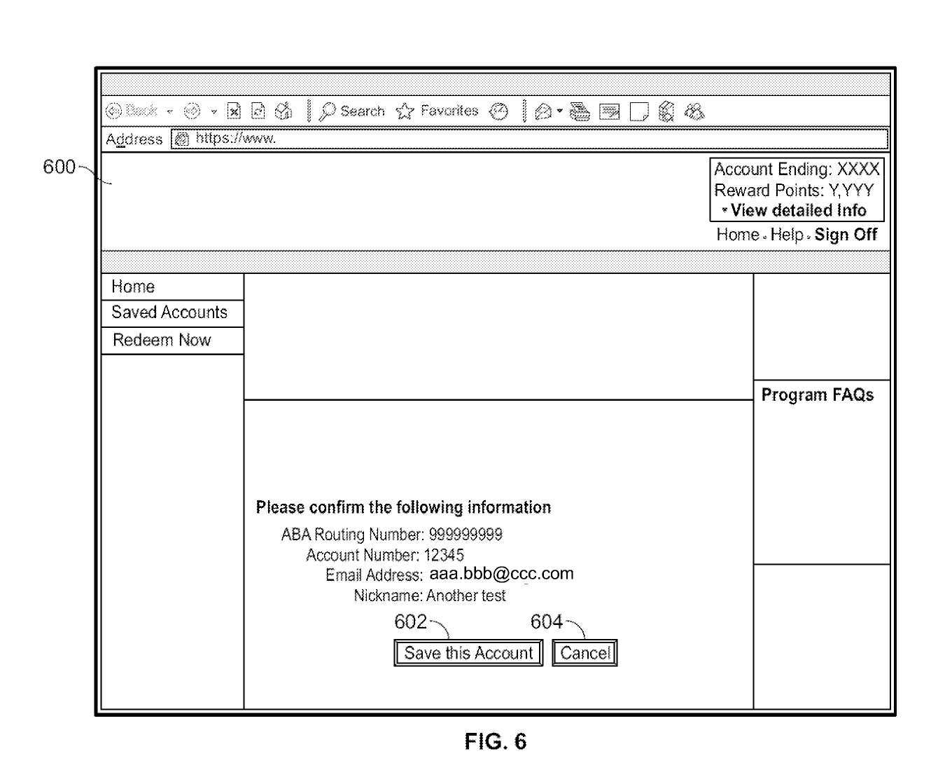

FIG. 6 illustrates one example confirmation screen 600. Once the user has input the requested information on the account information input screen 500 and selected save account option, the user may be prompted to review the information that has been input and confirm that it is correct, such as on screen 600. If correct, the user can save the information by selecting save button 602 or may select a cancel option 604 to return to the previous screen to make corrections or begin again.

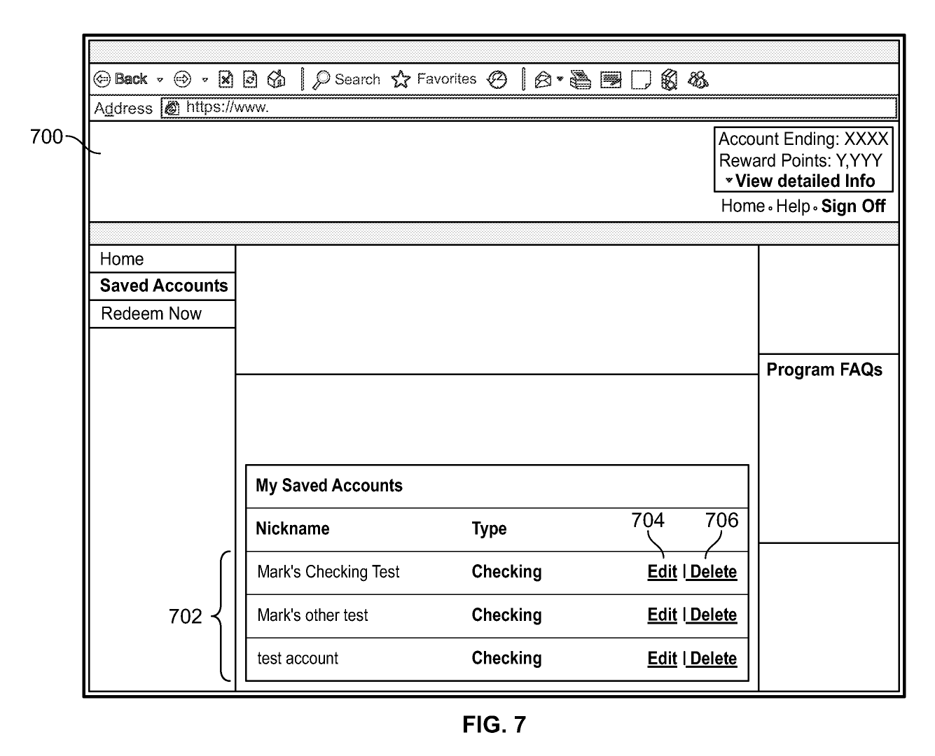

With further reference to FIG. 4, a user may select a saved accounts option 410 in order to review any accounts saved in the system. Selection of this option 410 may prompt an account listing screen, such as screen 700 shown in FIG. 7. The account listing screen 700 includes saved accounts 702 associated with the user. The accounts 702 may be listed by account number, portion of an account number or, as shown, by nickname. The type of account may also be listed. The user may select an account to which a reward credit should be deposited by clicking, double-clicking, etc. the desired account. The user may also edit or delete an account by selection option 704 to edit or 706 to delete.

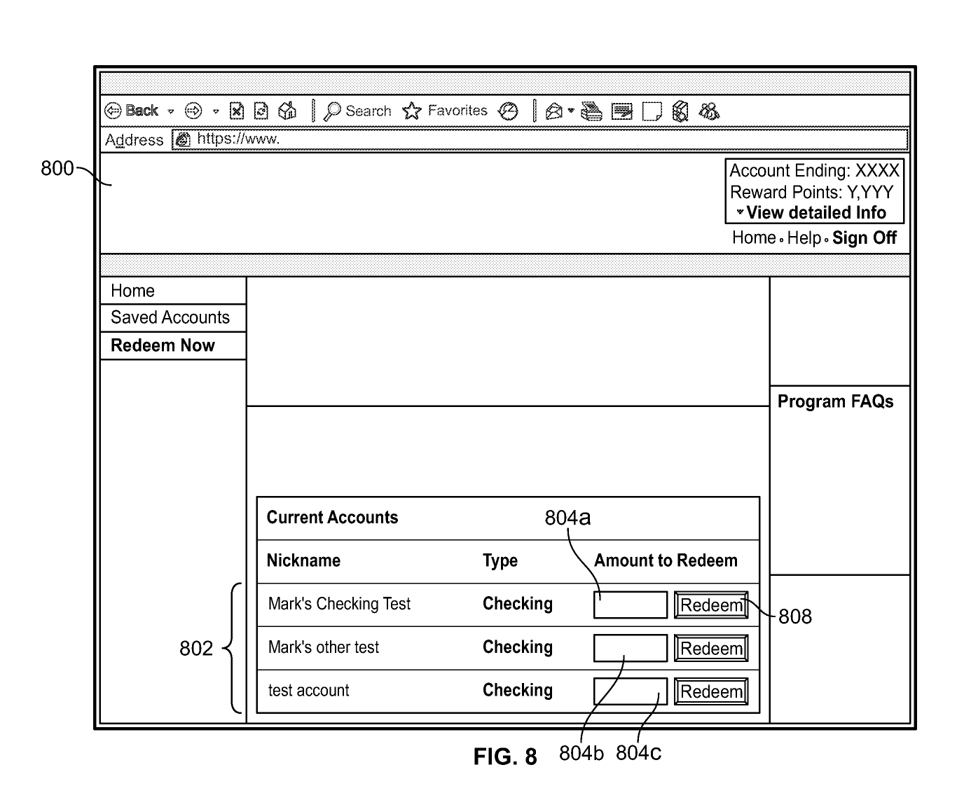

With further reference to FIG. 4, the user may select a redeem now option 412. Selection of this option 412 may display a reward redemption screen 800, as shown in FIG. 8. The reward redemption screen 800 may include one or more saved accounts 802 associated with the user. In some arrangements, a most recently accessed account may appear. In other arrangements, an account accessed most often may appear for selection for redemption. In still other arrangements, such as shown in FIG. 8, all eligible user accounts 802 may be displayed. Each account may have a redemption amount field 804a-804c associated with it. The user may input a desired amount to redeem in redemption amount field 804a-804c associated with the one or more selected accounts. The amount input may be any amount including whole dollars and partial dollars (i.e., change). In other arrangements, a minimum amount to redeem may be required. For instance, a user may only redeem amounts in excess of a predetermined minimum. The minimum may be specific to the type of account, financial institution sponsoring the redemption program, financial institution housing the account receiving the credit, etc.

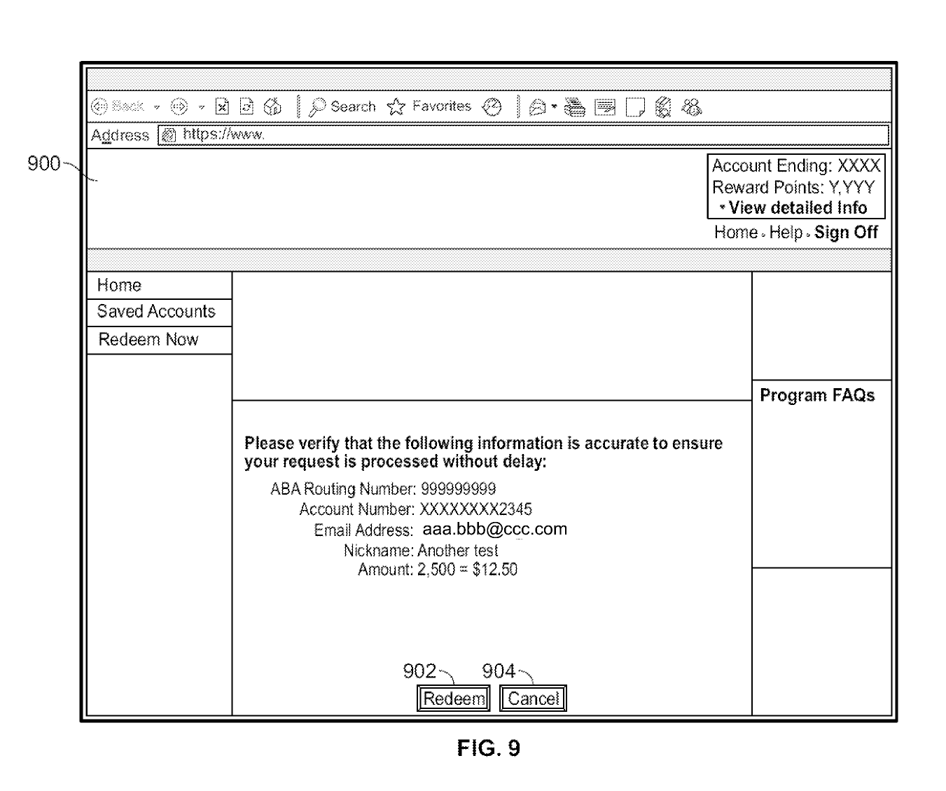

In one example, a user may select to redeem $12.50 in one account. The user may input the amount in the redemption amount field associated with the desired account and may select the redeem button 808 associated with that account. Selection of the redeem button 808 may prompt a confirmation screen, such as screen 900 in FIG. 9, which indicates the account to which the deposit will be credited, the amount to be credited and may include additional information such as the account number, partial account number, and the like. The user may then select a redeem option 902 to have the desired redemption amount of cash deposited to the desired account. Alternatively, the user may select a cancel option 904 to return to a previous screen or begin again.

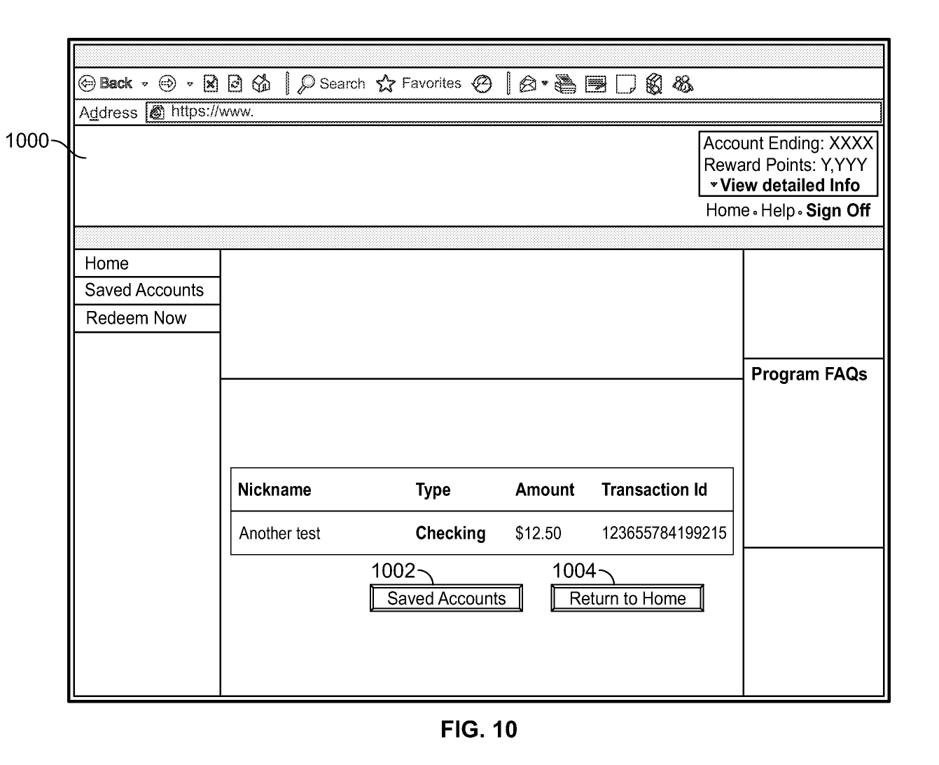

Once the redemption request is processed, a redemption request confirmation screen, such as screen 1000 in FIG. 10, may be displayed. The redemption request confirmation screen 1000 generally includes the name of the account to which the deposit was made, the amount of deposit, and may include a confirmation or tracking number, such as transaction identification number. At this point, the redemption transaction may be complete and a user may return to a saved accounts page via button 1002 or return to a home page via button 1004.

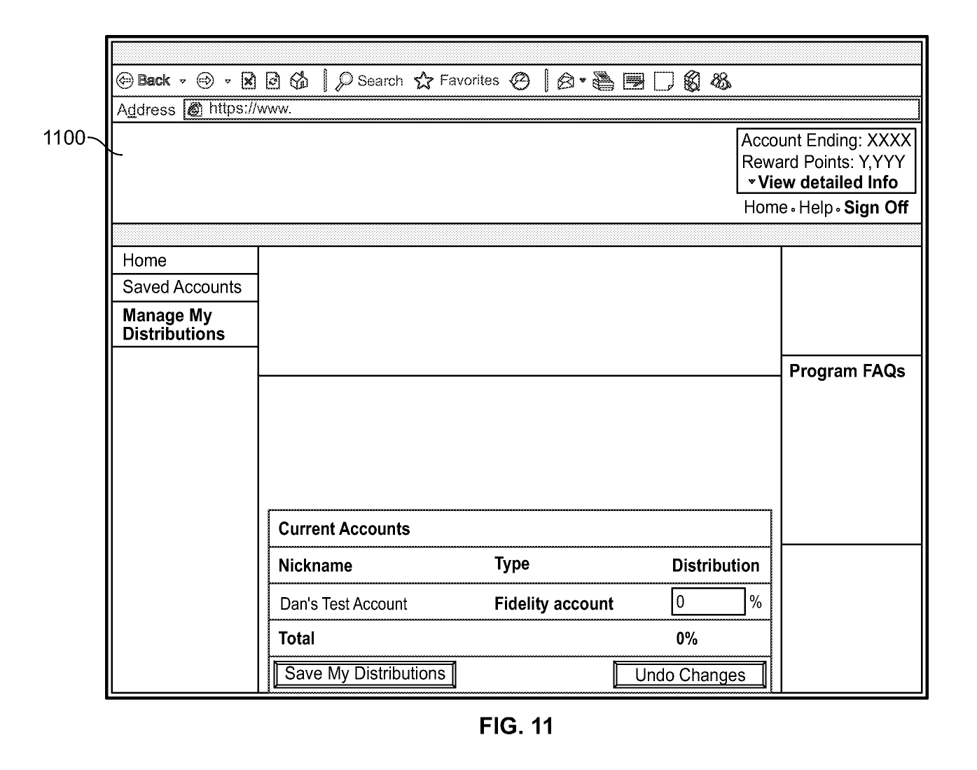

FIG. 11 illustrates an alternate arrangement for redemption of rewards to be deposited to a checking or savings account. Rather than selecting an amount to be deposited to an account in an on-demand fashion, a deposit may be made to a selected account automatically upon reaching a predetermined threshold or occurrence of a predetermined triggering event. For instance, a user may select an account to which the deposit will be made and may select a percentage of available reward points or credits to be converted to cash and deposited in the desired account, such as from screen 1100. In some arrangements, the available points may be redeemed and, if multiple accounts are selected, a percentage of the redeemed funds to be deposited to each account may be selected. Once the redemption is established, the desired percentage will automatically be transferred to the selected account upon occurrence of the triggering event or upon reaching the predetermined threshold. In some arrangements, the predetermined threshold may be a minimum amount to redeem as established by the program sponsor, financial institution etc. In other arrangements, the predetermined threshold may be a predetermined amount of reward points or credits as determined by a user. For instance, a user may establish that, when their reward account balance reaches, for example, 5000 credits or points, a percentage of those points will be converted to cash and deposited in the desired account automatically. Additionally or alternatively, the user may select to have the desired amount automatically redeemed and deposited on a recurring basis, such as monthly, semi-annually, and the like.

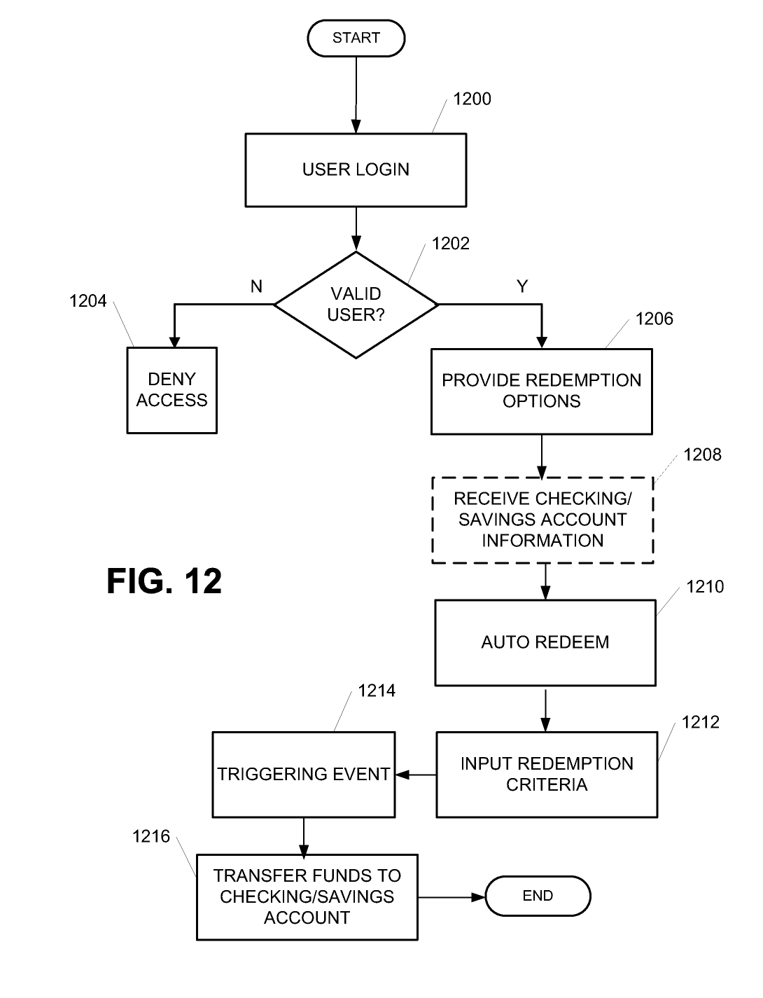

FIG. 12 illustrates one example of this automatic method of redemption of funds using the universal savings director described herein. In step 1200, user login information is received. The user login information may be received at a central server as described above. In step 1202, the user is authenticated to the system. If the login information is invalid, access to the universal savings director system will be denied in step 1204. If the login information is valid, the user will be presented with redemption options in step 1206. These redemption options may include various methods or forms of redemption, for instance, redemption for airline miles, credit card account credit, cash deposit to checking or savings account, and the like. In optional step 1208, checking and/or savings account information associated with one or more accounts of the user may be input into the system in order to credit those accounts with rewards. If user accounts have already been saved in the system, or once the user account information has been input, a redemption option, such as auto redeem in step 1210 may be selected. Upon selection of the auto redeem option 1210, a user may be prompted to select input various redemption criteria in step 1212. The redemption criteria may include one or more accounts to which a cash deposit of account rewards may be made, a percentage of award points to redeem, a number of award points to redeem, a predetermined threshold at which redemption should occur, a predetermined triggering event at which redemption should occur, and the like. The reward points will be automatically converted to cash and deposited into the selected account upon occurrence of a triggering event in step 1214. In some examples, reward points may be automatically redeemed for cash that is deposited in the selected account upon reaching a predetermined threshold. For instance, upon reaching 5000 reward points, the system may automatically convert those points to cash and deposit the cash in the selected account. In an alternate arrangement, a percentage of the points available at the threshold may be redeemed for cash. For instance, upon reaching 5000 points, the system may automatically convert half the points to cash and deposit in the selected account. The user and/or program sponsor may determine the threshold, percentage, etc.

In other examples, the system may automatically redeem available award points upon occurrence of an event, such as a predetermined day of the month. That is, a user may select to have available points, or a portion of the points, automatically redeem as cash equivalent and automatically deposit the cash into the predetermined account on a predetermined frequency such as daily, monthly or quarterly. In some arrangements, the user may be able to only redeem the entire balance of available points.

Upon reaching the predetermined threshold or occurrence of the triggering event, the cash will be deposited into the desired account in step 1216. This automated redemption of credits as cash that is deposited to a selected account may be engaged and disengaged as desired by the user, program sponsor, and the like.

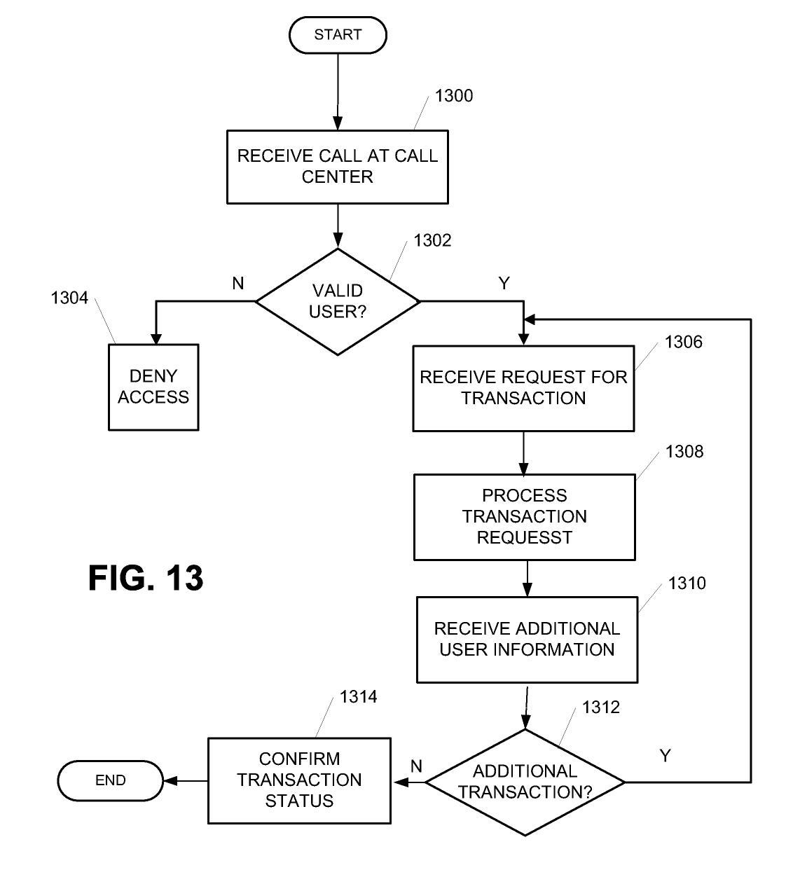

Although the above examples of depositing reward points redeemed as cash directly to a checking and/or savings account are discussed in the context of setting-up, controlling, etc. the transactions via a computer user-interface, in some arrangements, the transactions may be set-up and/or controlled via a call center transaction. FIG. 13 illustrates one example call center transaction in which a user may perform the functions described above. In step 1300, a call is received at the call center. In step 1302, the user is validated. If the user credentials are invalid, access to the system is denied in step 1304. If the user is valid, a call center operator, which may be an automated system or human operator, then receives the request for transaction in step 1306. The request for transaction may include a request to input checking and/or savings account information into the system to which deposits may be made from the reward program, an on-demand redemption request, an auto redeem set-up request, and the like. The call center operator may then process the requested transaction in step 1308. Processing the transaction may include receiving additional user information in step 1310, such as bank routing numbers and account numbers for accounts to be input, amount of desired redemption, etc. Upon completion of the transaction, the user will be prompted to conduct another transaction in step 1312, which may include additional user input if another transaction is desired. If no additional transactions are requested, the call center may confirm the status of transactions conducted in step 1314 and the call will be ended.

In these call center operator arrangements, the call center operator fielding the call may also be validated on the system. For instance, the call center operator may be logged in as an employee and, when the call center operator validates the customer information, the system may give permission for the call center operator to have the same capability to revise account information, add account information, etc. as the customer. This validation may be based on permissions given to the call center operator.

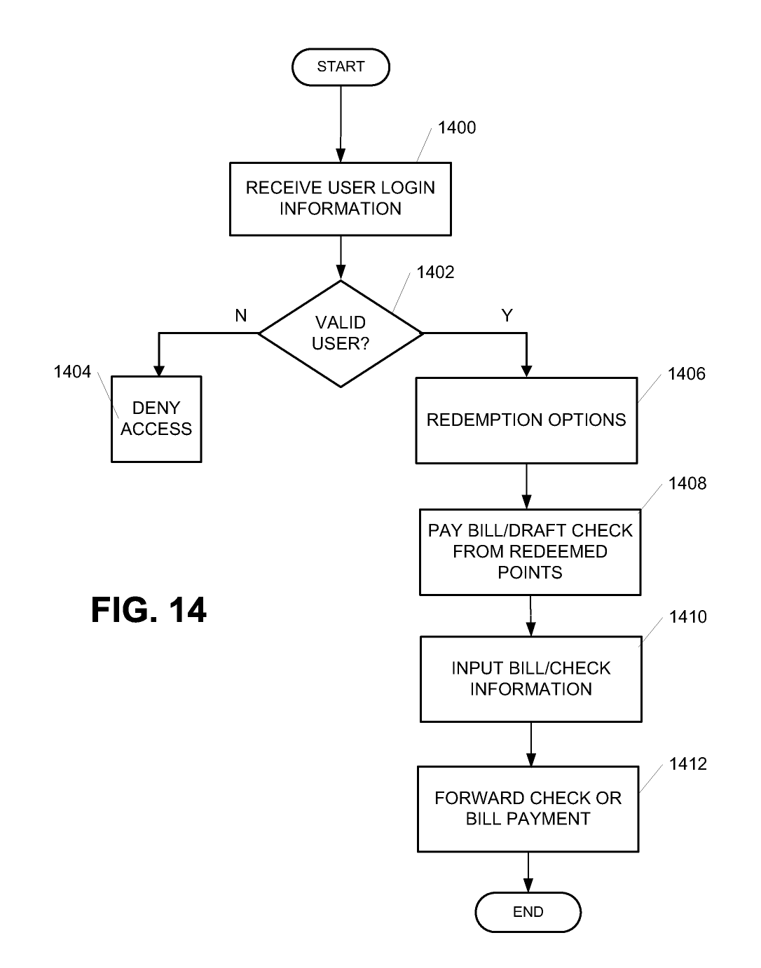

In some arrangements, a user may select to directly write a check or pay a bill from the redeemed cash amount that would be deposited to the checking and/or savings account. For instance, the user may select pay a bill from the cash equivalent of redeemed points. FIG. 14 illustrates one example method of drafting checks from the redeemed points. In step 1400, user login information is received. The user login information may be received at a central server as described above. In step 1402, the user is authenticated to the system. If the login information is invalid, access to the universal savings director system will be denied in step 1404. If the login information is valid, the user may be presented with redemption options in step 1406. These redemption options may include an option to redeem points and pay bills or draft checks from the cash equivalent of the redeemed points, such as step 1408. In step 1410 the user may input the desired bill or check information. In step 1412 the financial institution may draft the check and forward directly to the receiving party or pay the bill.

The universal savings director system described herein permits management of reward accounts on an individual basis. For example, conventional reward redemption systems only allow redemption as a credit to the credit card account, use of points to make purchases, and the like. However, the redemption method was not particular to a specific user. The system described herein permits redemption to existing accounts specific to a user, thereby allowing redemption of points to be better tailored to the individual user.

Although not required, one of ordinary skill in the art will appreciate that various aspects described herein may be embodied as a method, a data processing system, or as one or more computer-readable media storing computer-executable instructions. Accordingly, those aspects may take the form of an entirely hardware embodiment, an entirely software embodiment or an embodiment combining software and hardware aspects. In addition, various signals representing data or events as described herein may be transferred between a source and a destination in the form of light and/or electromagnetic waves traveling through signal-conducting media such as metal wires, optical fibers, and/or wireless transmission media (e.g., air and/or space).

Aspects of the invention have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the disclosure.

What is claimed is:

1. A system for redemption of rewards from a credit card reward program, comprising:
a user interface module for receiving account information identifying an account into which rewards converted into cash are deposited;
a back end resolution module for determining if a predetermined condition is met; and
a finalization module for depositing cash into the account when the predetermined condition is met.

2. The system of claim 1, wherein the predetermined condition is at least one of a predetermined calendar day, a predetermined reward points value, predetermined frequency and a predetermined lapse of time.

3. The system of claim 1, wherein the account information further includes an account nickname.

4. The system of claim 1, wherein depositing the cash into the account is performed automatically when the predetermined condition is met.

5. The system of claim 1, wherein the finalization module further is for transmitting a confirmation of completion of the deposited cash.

6. The system of claim 1, wherein the account is a pre-existing account associated with a user.

7. The system of claim 1, wherein the account is at least one of a checking account, savings account, mortgage account, brokerage account and retirement account.

8. A method of redeeming rewards from a credit card rewards program, comprising:
receiving, at a central server, information relating to an account of a user;
determining, at the central server, that a predetermined condition has been met;
responsive to determining that the predetermined condition has been met, redeeming points in a reward balance for cash; and
depositing the cash into the account.

9. The method of claim 8, wherein the account is at least one of a checking, savings, mortgage, brokerage or retirement account of the user.

10. The method of claim 8, wherein the information relating to the account includes a nickname for the checking or savings account.

11. The method of claim 8, wherein the predetermined condition is a least one of a predetermined calendar day, predetermined reward balance threshold, predetermined frequency and predetermined lapse of time.

12. The method of claim 8, wherein the step of redeeming points in a reward balance for cash includes redeeming a predetermined percentage of point for cash.

13. The method of claim 8, wherein the steps of redeeming points in the reward balance for cash and depositing the cash into the account is performed automatically upon determining that the predetermined condition has been met.

14. The method of claim 8, further including receiving, at the central server, information relating to a plurality of user accounts.

15. The method of claim 14, wherein the step of depositing the cash into the account includes depositing the cash into a selected checking or savings account from the plurality of user accounts.

16. The method of claim 8, responsive to redeeming points in a reward balance for cash and prior to depositing the cash into the account, receiving payment information for paying a bill from the redeemed cash amount and paying the bill using the redeemed cash funds.

17. A method of redeeming reward points for cash, comprising:
receiving account information relating to a checking or savings account of a user;
storing the received account information;
receiving user input to redeem points from a reward balance for cash;
redeeming points from the reward balance for cash;
receiving user input selecting an account associated with the stored account information; and
depositing the cash into the account associated with the stored account information.

18. The method of claim 17, wherein the step of receiving account information relating to a checking or savings account of a user includes receiving account information relating to a plurality of checking or savings accounts of the user.

19. The method of claim 17, wherein the step of receiving account information relating to a checking or savings account of the user includes receiving a nickname associated with the checking or savings account.

20. The method of claim 17, wherein the checking or savings account is a pre-existing account of the user.

21. The method of claim 17, further including transmitting a confirmation of the deposit to the user.

22. One or more computer-readable media storing computer readable instructions that, when executed, cause a processor to perform a method, comprising:
receiving account information relating to a checking or savings account of a user;
storing the received account information;
receiving user input to redeem points from a reward balance for cash;
receiving user input selecting an account associated with the stored account information; and
depositing the cash into the account associated with the stored account information.

23. The method of claim 22, wherein the step of receiving account information relating to a checking or savings account of a user includes receiving account information relating to a plurality of checking or savings accounts of the user.

24. The method of claim 22, wherein the step of receiving account information relating to a checking or savings account of the user includes receiving a nickname associated with the checking or savings account.

25. The method of claim 22, wherein the checking or savings account is a pre-existing account of the user.

26. The method of claim 22, further including transmitting a confirmation of the deposit to the user.
